(19) United States
(12) Patent Application Publication
(10) Pub. No.: US 2021/0170641 A1
(43) Pub. Date: Jun. 10, 2021

(54) METHOD FOR MANUFACTURING A RECYCLABLE TOY

(71) Applicant: GREAT EASTERN ENTERTAINMENT CO, Compton, CA (US)

(72) Inventor: Kent HSU, Compton, CA (US)

(73) Assignee: GREAT EASTERN ENTERTAINMENT CO, Compton, CA (US)

(21) Appl. No.: 16/702,843

(22) Filed: Dec. 4, 2019

(51) Int. Cl. B29C 41/00; B29C 41/16; B29C 41/50

(52) U.S. Cl. CPC B29C 41/003; B29L 2031/5209; B29C 41/50; B29C 41/16

(57) ABSTRACT

The invention discloses a recyclable toy and the manufacturing method thereof, the method comprising the following steps: S1, according to the designed shape of the toy, manufacturing a pulp sucking molding die and a hot press shaping die with a corresponding shape, and conducting trimming by a die cutter; S2, placing the pulp sucking molding die in a pulp containing tank so that the pulp sucking molding die sucks the pulp, and demolding to obtain a toy wet green; S3, using the hot press shaping die to hot press the toy wet green for shaping by a hot press machine so as to obtain the recyclable toy. The invention provides a toy and a method using pulp as a raw material. The manufactured toy has good quality, contains recyclable material and is environmentally friendly, which is firstly seen in the field of toy manufacturing.

### TECHNICAL FIELD

The invention relates to the technical field of toy manufacturing, specifically to a recyclable toy and the manufacturing method thereof.

### BACKGROUND

At present, a considerable number of toys are usually made of materials such as plastics, which are difficult to recycle for other purposes. In order to avoid wasting, most of the time recycling of toys can only be achieved by trading among consumers.

### SUMMARY

In view of the deficiencies of the prior art, the present invention aims to provide a recyclable toy and the manufacturing method thereof, which uses pulp as a raw material for manufacturing a toy so as to realize recycling of the toy and become more environmentally friendly.

In order to achieve the above object, the present invention adopts the following technical solutions:

A method for manufacturing a recyclable toy comprises the following steps:
S1, according to the designed shape of the toy, manufacturing a pulp sucking molding die and a hot press shaping die with a corresponding shape, and conducting trimming by a die cutter;
S2, placing the pulp sucking molding die in a pulp containing tank so that the pulp sucking molding die sucks the pulp, and demolding to obtain a toy wet green;
S3, using the hot press shaping die to hot press the toy wet green for shaping by a hot press machine so as to obtain the recyclable toy.

Further, if the toy to be manufactured has a 3D structure, in S1, two pulp sucking molding dies are manufactured according to the designed shape of the toy, the two pulp sucking molding dies being respectively matched with two parts of the toy; in S2, two toy wet greens are respectively obtained by the two pulp sucking molding dies; in S3, the two toy wet greens are hot pressed for shaping by a hot press machine followed by combination and adhesion thereof so as to obtain a complete recyclable toy is obtained.

Further, said hot press for shaping in S3 has an upper die temperature of 180-200° C. and a lower die temperature of 150-160° C.

Further, the pulp comprises 20% of extracted pulp, 30% of crude wood pulp, and 50% of water by weight, wherein the extracted pulp is mainly prepared from a mixture of ordinary waste paper and long-fiber kraft paper, and a mass ratio of the long-fiber kraft paper and the ordinary waste paper is greater than or equal to 1:1.

Further, the toy wet green obtained in S2 has a thickness of 2 mm, and has a thickness of 0.8 mm after said hot press for shaping in S3.

Further, a plurality of rows of vents are provided on the hot press shaping die, wherein each row of the vents has a distance of 20 cm, and a pore size of the vents is 2 mm.

A recyclable toy is further provided by the invention which is made of pulp.

Beneficial effects of the invention are as follows:

The invention provides a toy and a method using pulp as a raw material. The manufactured toy has good quality, contains more readily recycled and reused material, and is environmentally friendly, which is firstly seen in the field of toy manufacturing.

### DETAILED DESCRIPTION OF EMBODIMENTS

The present invention will be further described below. It should be noted that the present embodiment provides a detailed implementation manner and a specific procedure based on the present technical solution, but the scope of protection of the present invention is not limited to the embodiment.

A method for manufacturing a recyclable toy comprises the following steps:
S1, according to the designed shape of the toy, manufacturing a pulp sucking molding die and a hot press shaping die (both of which may be an Al die) with a corresponding shape, and conducting trimming by a die cutter;
S2, placing the pulp sucking molding die in a pulp containing tank so that the pulp sucking molding die sucks the pulp, and demolding to obtain a toy wet green;
S3, using the hot press shaping die to hot press the toy wet green for shaping by a hot press machine so as to obtain the recyclable toy. The hot pressed and shaped toy has high tightness and smooth surface without any crack.

For further description, if the toy to be manufactured has a 3D structure, in S1, two pulp sucking molding dies are manufactured according to the designed shape of the toy, the two pulp sucking molding dies being respectively matched with two parts of the toy; in S2, two toy wet greens are respectively obtained by the two pulp sucking molding dies; in S3, the two toy wet greens are hot pressed for shaping by a hot press machine followed by combination and adhesion thereof so as to obtain a complete recyclable toy is obtained.

For further description, the pulp sucking molding die may be a conventional pulp sucking molding die. The pulp sucking molding die has an inner cavity adapted to the shape of a toy or a part of a toy, the inner cavity being open and having a filter on its open side. A pulp sucking hole is provided on an outer wall of the pulp sucking molding die. When the pulp sucking molding die is placed in a pulp containing tank, the pulp enters the inner cavity through the pulp sucking hole under negative pressure. The moisture of the pulp is filtered out through the filter and the rest pulp stays in the inner cavity, thereby forming a toy wet green.

For further description, said hot press for shaping in S3 has an upper die temperature of 180-200° C. and a lower die temperature of 150-160° C.

For further description, the pulp comprises 20% of extracted pulp, 30% of crude wood pulp, and 50% of water by weight, wherein the extracted pulp is mainly prepared from a mixture of ordinary waste paper and long-fiber kraft paper, and a mass ratio of the long-fiber kraft paper and the ordinary waste paper is greater than or equal to 1:1.

For further description, the toy wet green obtained in S2 has a thickness of 2 mm, and has a thickness of 0.8 mm after said hot press for shaping in S3.

For further description, a plurality of rows of vents are provided on the hot press shaping die, wherein each row of the vents has a distance of 20 cm, and a pore size of the vents is 2 mm.

A recyclable toy is further provided by the invention which is made of pulp. Specifically, a recyclable toy made by the above method is provided.

A person skilled in the art can make various changes and modifications in accordance with the above technical solutions and concepts, and all such changes and modifications are intended to be included within the scope of the appended claims.

1. A method for manufacturing a recyclable toy, wherein the following steps:
S1, according to the designed shape of the toy, manufacturing a pulp sucking molding die and a hot press shaping die with a corresponding shape, and conducting trimming by a die cutter;
S2, placing the pulp sucking molding die in a pulp containing tank so that the pulp sucking molding die sucks the pulp, and demolding to obtain a toy wet green; and
S3, using the hot press shaping die to hot press the toy wet green for shaping by a hot press machine so as to obtain the recyclable toy.

2. The method for manufacturing a recyclable toy according to claim 1, wherein, if the toy to be manufactured has a 3D structure, in S1, two pulp sucking molding dies are manufactured according to the designed shape of the toy, the two pulp sucking molding dies being respectively matched with two parts of the toy; in S2, two toy wet greens are respectively obtained by the two pulp sucking molding dies; in S3, the two toy wet greens are hot pressed for shaping by a hot press machine followed by combination and adhesion thereof so as to obtain a complete recyclable toy is obtained.

3. The method for manufacturing a recyclable toy according to claim 1, wherein, said hot press for shaping in S3 has an upper die temperature of 180-200° C. and a lower die temperature of 150-160° C.

4. The method for manufacturing a recyclable toy according to claim 1, wherein, the pulp comprises 20% of extracted pulp, 30% of crude wood pulp, and 50% of water by weight, wherein the extracted pulp is mainly prepared from a mixture of ordinary waste paper and long-fiber kraft paper, and a mass ratio of the long-fiber kraft paper and the ordinary waste paper is greater than or equal to 1:1.

5. The method for manufacturing a recyclable toy according to claim 1, wherein, the toy wet green obtained in S2 has a thickness of 2 mm, and has a thickness of 0.8 mm after said hot press for shaping in S3.

6. The method for manufacturing a recyclable toy according to claim 1, wherein, a plurality of rows of vents are provided on the hot press shaping die, wherein each row of the vents has a distance of 20 cm, and a pore size of the vents is 2 mm.
